(19) United States
(12) Patent Application Publication
(10) Pub. No.: US 2019/0329532 A1
(43) Pub. Date: Oct. 31, 2019

(54) PRECERAMIC ADHESIVE COMPOSITION

(71) Applicant: United Technologies Corporation, Farmington, CT (US)

(72) Inventors: Paul Sheedy, Bolton, CT (US); Wayde R. Schmidt, Pomfret Center, CT (US); Erica L. Prevost, Arlington, MA (US); Alex J. Sember, Waterbury, CT (US)

(21) Appl. No.: 16/259,290

(22) Filed: Jan. 28, 2019

Related U.S. Application Data
(63) Continuation of application No. 14/917,961, filed on Mar. 10, 2016, now abandoned.
(60) Provisional application No. 61/876,854, filed on Sep. 12, 2013.

(51) Int. Cl. B32B 18/00; C04B 35/563; C04B 35/581; C04B 35/571; C09J 5/00; C04B 35/10; C04B 35/74; C04B 35/583; C04B 35/589

(52) U.S. Cl. CPC B32B 18/00; C04B 35/563; C04B 35/581; C04B 35/571; C09J 5/00; C04B 35/10; C08G 77/62; C04B 35/583; C04B 35/589; C09J 2483/00; C09J 2400/12; C09J 2400/263; C04B 35/74

(57) ABSTRACT

A method of preparing a composite preform includes applying a tacky preceramic-polymer-based adhesive on a first fiber array arranging a second fiber array on the first fiber array, the adhesive holding the first and second fiber arrays together. A composite component is also disclosed.

### CROSS-REFERENCE TO RELATED APPLICATION

This application is a continuation of U.S. application Ser. No. 14/917,961, filed Mar. 10, 2016, which claims priority to PCT/US2014/051973, filed Aug. 21, 2014, which claims priority to U.S. Provisional Application No. 61/876,854, filed Sep. 12, 2013.

### BACKGROUND

This disclosure relates to a method for preparing a ceramic preform using a preceramic tackifier.

Composite materials can be formed by arranging multiple fiber arrays relative to one another in a lay-up process and infiltrating the fiber arrays with a matrix material. During the lay-up and infiltration process, the fiber arrays may be held together by a fugitive adhesive. The adhesive burns off either prior to or during molding.

### SUMMARY

A method of preparing a composite preform according to an exemplary aspect of the present disclosure includes applying a tacky preceramic-polymer-based adhesive on a first fiber array and arranging a second fiber array on the first fiber array, the adhesive holding the first and second fiber arrays together.

In a further embodiment of the foregoing embodiment, the tacky preceramic-polymer-based adhesive includes at least one of polycarbosilane, polycarbosiloxane, and polysilazane.

In a further embodiment of any of the foregoing embodiments, the tacky preceramic-polymer-based adhesive includes a resin phase and a filler phase.

In a further embodiment of any of the foregoing embodiments, the tacky preceramic-polymer-based adhesive includes 60% or less of the filler phase by weight.

In a further embodiment of any of the foregoing embodiments, the filler phase includes at least one of a carbide, a nitride, an oxycarbide, an oxynitride, and an oxide.

In a further embodiment of any of the foregoing embodiments, the method further includes debulking the first and second fiber arrays subsequent to the arranging step.

In a further embodiment of any of the foregoing embodiments, the tacky preceramic-polymer-based adhesive is a tape, a laminate, or a paste.

In a further embodiment of any of the foregoing embodiments, the method further includes applying the tacky preceramic-polymer-based adhesive is by at least one of painting, spreading, dipping, and spraying.

In a further embodiment of any of the foregoing embodiments, applying includes depositing a layer of tacky preceramic-polymer-based adhesive less than 10 mils (254 μm) thick.

In a further embodiment of any of the foregoing embodiments, applying is performed at a first temperature, and further comprising the step of changing the temperature of the first fiber array and tacky preceramic-polymer-based adhesive to a second temperature higher than the first temperature.

In a further embodiment of any of the foregoing embodiments, applying is performed at a first temperature, and further comprising the step of changing the temperature of the first fiber array and tacky preceramic-polymer-based adhesive to a second temperature lower than the first temperature.

A method of making a composite component according to an exemplary aspect of the present disclosure includes infiltrating first and second fiber arrays with a matrix material to form a component, the first and second fiber arrays adhered to one another by a preceramic-polymer-based adhesive, and converting the preceramic-polymer-based adhesive into an integral ceramic phase of the component.

In a further embodiment of any of the foregoing embodiments, the tacky preceramic-polymer-based adhesive includes a resin phase and a filler phase.

In a further embodiment of any of the foregoing embodiments, the filler participates in a reaction with at least one of the resin phase and the matrix material during the converting step.

In a further embodiment of any of the foregoing embodiments, the filler includes a metal.

A ceramic matrix composite component according to an exemplary aspect of the present disclosure includes a ceramic matrix material, a first discrete fiber array and a second discrete fiber array within the matrix material, and a discrete ceramic phase in a localized region of an interface between the first and second discrete fiber arrays.

In a further embodiment of any of the foregoing embodiments, the discrete ceramic phase includes at least one of silicon carbide, silicon oxycarbide, silicon nitride, boron carbide, boron nitride, silicon nitride carbide, silicon carbide nitride, aluminum nitride, aluminum oxynitride, and aluminum oxide.

In a further embodiment of any of the foregoing embodiments, the discrete ceramic phase includes a filler phase dispersed in the discrete ceramic phase.

In a further embodiment of any of the foregoing embodiments, the filler phase includes a metal.

In a further embodiment of any of the foregoing embodiments, the first and second discrete fiber arrays are ceramic-based.

In a further embodiment of any of the foregoing embodiments, the discrete ceramic phase is less than 10 mils (254 μm) thick.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 is a flow chart of a method of preparing a ceramic preform.

FIG. 2 schematically illustrates a cross-sectional view of a ceramic component made from the ceramic preform.

### DETAILED DESCRIPTION

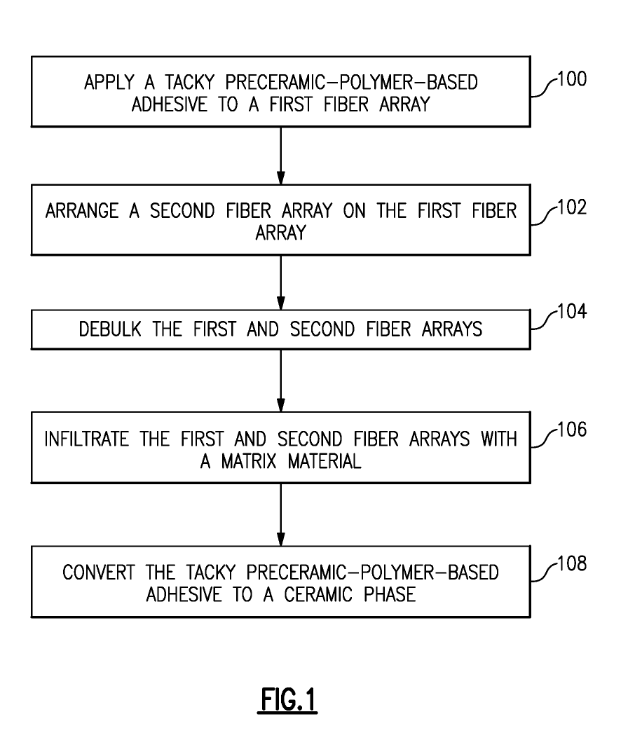

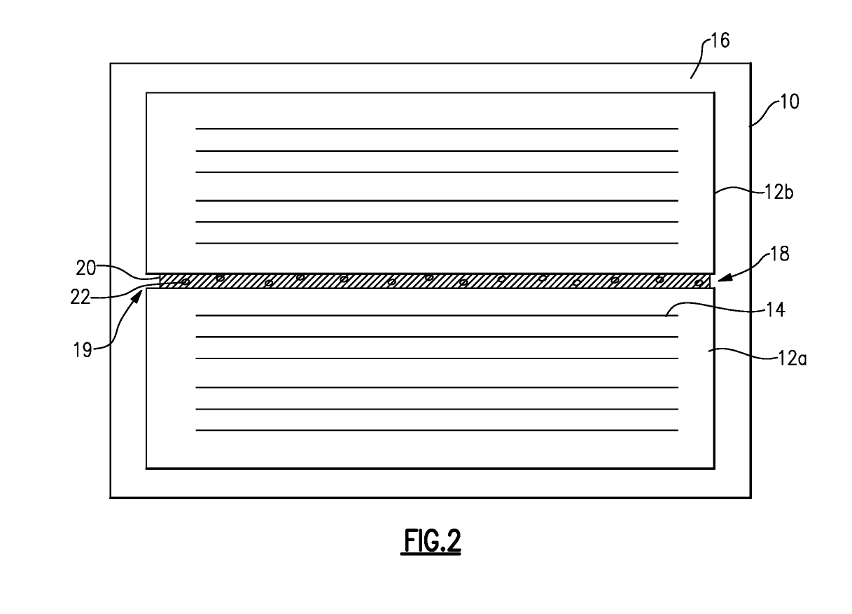

FIG. 1 shows a method of preparing a ceramic preform. FIG. 2 illustrates a cross-sectional view of a ceramic component 10 made from the ceramic preform formed by the method of FIG. 1. As will be discussed in more detail below, the disclosed method utilizes a tacky preceramic-polymer-based adhesive during a fiber arrangement process which becomes an integral part of the final ceramic component made from the preform.

In step 100, a tacky preceramic-polymer-based adhesive is applied to a first fiber array 12a. In one example, the tacky preceramic-polymer-based adhesive is deposited onto the first fiber array 12a in a layer less than 10 mils (254 μm) thick. More particularly, the layer of tacky preceramic-polymer-based adhesive can be between 1.5 mils and 3 mils (38.1 μm to 76.2 μm) thick. In step 102, a second fiber array 12b is arranged on the first fiber array 12a such that the adhesive holds the first and second fiber arrays 12a, 12b together. In another example, the tacky preceramic-polymer-based adhesive can also be applied to the second fiber array 12b prior to the arranging step 102.

Each of the first and second fiber arrays 12a, 12b includes a plurality of fibers 14. The first and second fiber arrays 12a, 12b can be bundles of fibers 14, called “tows.” In another example the first and second fiber arrays 12a, 12b can include multiple fibers 14 arranged parallel to one another, randomly within the first and second arrays 12a, 12b, or in another arrangement. The fibers 14 can be, in one example, ceramic-based.

The tacky preceramic-polymer-based adhesive can be applied to the first and/or second fiber arrays 12a, 12b by, for instance, painting, spreading, dipping, or spraying. In an alternate example, the tacky preceramic-polymer-based adhesive can be applied to the first and/or second fiber arrays 12a, 12b as a tape, laminate, or paste. The tacky preceramic-polymer-based adhesive can have adhesive properties which are temperature dependent. For example, the tacky preceramic-polymer-based adhesive can be applied to the first and/or second fiber arrays 12a, 12b at a first temperature, and may then be heated to a second, higher temperature which can cause the tackiness of the tacky preceramic-polymer-based adhesive to increase. In an alternate example, the tacky preceramic-polymer-based adhesive can be heated to a first temperature prior to application to the first and/or second fiber arrays 12a, 12b to decrease the viscosity and simplify the application, and then may be cooled to a second lower temperature to solidify the tacky preceramic-polymer-based adhesive. In a further example, the tacky preceramic-polymer-based adhesive can be applied to the first and/or second fiber arrays 12a, 12b at a first, high temperature, then the first and/or second fiber arrays 12a, 12b and the tacky preceramic-polymer-based adhesive can be cooled to a second, low temperature.

The tacky preceramic-polymer-based adhesive can be applied to the first fiber array 12a such that it only covers at least a portion of the surface of the first fiber array 12a. In one example, the tacky preceramic-polymer-based adhesive covers the entire surface of the first fiber array 12a, but in another example, the tacky preceramic-polymer-based adhesive layer may be discontinuous. Alternatively, the tacky preceramic-polymer-based adhesive can partially or fully infiltrate into the fiber array 12a. Likewise, the tacky preceramic-polymer-based adhesive can be only covering the surface of the second fiber array 12b or may infiltrate into the second fiber array 12b. Said another way, the tacky preceramic-polymer-based adhesive may contact fibers 14 at the surface and/or in the interior of the first and second fiber arrays 12a, 12b.

In step 104, the first and second fiber arrays 12a, 12b are debulked. The debulking step removes air from within the first and second fiber arrays 12a, 12b and from in between the first and second fiber arrays 12a, 12b, for example, by compression. The debulking step 104 can be performed periodically during the arrangement step 102. In one example, additional fiber arrays may be added to the composite component by repeating steps 100 through 104.

In step 106, the first and second fiber arrays 12a, 12b are infiltrated with a matrix material 16. The matrix material 16 can be a resin. In one example, the matrix material 16 is convertible to a ceramic material, for example, by pyrolysis or thermal conversion. In step 108, the tacky preceramic-polymer-based adhesive is converted to a ceramic phase 18, for example, by pyrolysis. The ceramic phase 18 is an integral part of the matrix material 16 and is located at an interface 19 of the first and second fiber arrays 12a, 12b. In one example, the ceramic phase 18 may be indistinguishable from the matrix material 16. After the converting step 108, the ceramic phase 18 can still be less than 10 mils (254 μm) thick, or more particularly, between 1.5 mils and 3 mils (38.1 μm to 76.2 μm) thick.

In one example, the tacky preceramic-polymer-based adhesive and the resulting ceramic phase 18 can include a resin phase 20 and a filler phase 22. The filler phase 22 can be less than 60% of the tacky preceramic-polymer-based adhesive by weight. The resin phase 20 can be chosen such that the ceramic phase 18 includes at least one of silicon carbide, silicon oxycarbide, silicon nitride, boron carbide, boron nitride, silicon nitride carbide, silicon carbide nitride, aluminum nitride, aluminum oxynitride, and aluminum oxide after the converting step 108. For instance, the resin phase 20 can include at least one of polycarbosilane, polysilazane, and polycarbosiloxane. RD-730 preceramic resin (Starfire Systems, Inc., Schenectady, N.Y.) is one exemplary resin phase 20.

The filler phase 22 can include a carbide, a nitride, an oxide, an oxynitride or an oxycarbide. In another example, the filler phase 22 can include a reactive species such as a metal, carbon, or another reactive precursor, which can react with excess carbon in the matrix material 16 or the resin phase 20.

The tacky preceramic-polymer-based adhesive can be prepared by combining the filler phase 22 with the resin phase 20. The combining can be accomplished by reducing the viscosity of the resin phase 20, for example, by heating the resin phase 20, sufficiently such that the filler phase 20 can be blended in. In another example, the filler phase 22 can be mixed into the resin phase 20 at room temperature by high-shear mixing. In a further example, the resin phase 20 can be dissolved or partially dissolved in a solvent prior to mixing in the filler phase 22. The solvent can then be removed by high heat and/or reduced pressure.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

1. A method of preparing a composite preform, the method comprising:
applying a tacky preceramic-polymer-based adhesive on a first fiber array, wherein the tacky preceramic-polymer-based adhesive includes at least one of polycarbosilane, polycarbosiloxane, and polysilazane; and
arranging a second fiber array on the first fiber array, the adhesive holding the first and second fiber arrays together.

2. (canceled)

3. The method of claim 1, wherein the tacky preceramic-polymer-based adhesive includes a resin phase and a filler phase.

4. The method of claim 3, wherein the tacky preceramic-polymer-based adhesive includes 60% or less of the filler phase by weight.

5. The method of claim 22, wherein the filler phase includes at least one of a carbide, a nitride, an oxycarbide, an oxynitride, and an oxide.

6. The method of claim 1, further comprising debulking the first and second fiber arrays subsequent to the arranging step.

7. The method of claim 1, wherein the tacky preceramic-polymer-based adhesive is a tape, a laminate, or a paste.

8. The method of claim 1, including applying the tacky preceramic-polymer-based adhesive is by at least one of painting, spreading, dipping, and spraying.

9. The method of claim 1, wherein applying includes depositing a layer of tacky preceramic-polymer-based adhesive less than 10 mils (254 μm) thick.

10. The method of claim 1, wherein applying is performed at a first temperature, and further comprising the step of changing the temperature of the first fiber array and tacky preceramic-polymer-based adhesive to a second temperature higher than the first temperature.

11. The method of claim 1, wherein applying is performed at a first temperature, and further comprising the step of changing the temperature of the first fiber array and tacky preceramic-polymer-based adhesive to a second temperature lower than the first temperature.

12. A method of making a composite component, the method comprising:
infiltrating first and second fiber arrays with a matrix material to form a component, the first and second fiber arrays adhered to one another by a preceramic-polymer-based adhesive, wherein the tacky preceramic-polymer-based adhesive includes at least one of polycarbosilane, polycarbosiloxane, and polysilazane; and
converting the preceramic-polymer-based adhesive into an integral ceramic phase of the component.

13. The method of claim 12, wherein the tacky preceramic-polymer-based adhesive includes a resin phase and a filler phase.

14. The method of claim 13, wherein the filler participates in a reaction with at least one of the resin phase and the matrix material during the converting step.

15. The method of claim 14, wherein the filler includes a metal.

16. A ceramic matrix composite component, comprising:
a ceramic matrix material;
a first discrete fiber array and a second discrete fiber array within the matrix material; and
a discrete ceramic phase in a localized region of an interface between the first and second discrete fiber arrays, the discrete ceramic phase including a ceramic that is a product of converting a tacky preceramic-based-polymer including at least one of polycarbosilane, polysilazane, and polycarbosiloxane into a ceramic.

17. The component of claim 16, wherein the discrete ceramic phase includes at least one of silicon carbide, silicon oxycarbide, silicon nitride, silicon nitride carbide, silicon carbide nitride.

18. The component of claim 16, wherein the discrete ceramic phase includes a filler phase dispersed in the discrete ceramic phase.

19. The component of claim 18, wherein the filler phase includes a metal.

20. The component of claim 16, wherein the first and second discrete fiber arrays are ceramic-based.

21. The component of claim 16, wherein the discrete ceramic phase is less than 10 mils (254 μm) thick.

22. The method of claim 3, wherein the resin phase includes at least one of polycarbosilane, polycarbosiloxane, and polysilazane.

23. The method of claim 22, wherein the filler phase includes a reactive species that is reactive with carbon in the resin phase.

24. The method of claim 3, further comprising combining the filler phase with the resin phase to form the tacky preceramic-polymer-based adhesive prior to the applying.

25. The method of claim 24, further comprising reducing the viscosity of the resin phase during the combining.

26. The method of claim 25, wherein the viscosity of the resin phase is reduced by heating the resin phase.

27. The method of claim 24, wherein the combining is by high-shear mixing.

28. The method of claim 24, further comprising:
at least partially dissolving the resin phase in a solvent prior to the combining; and
removing the solvent after the combining.

29. The method of claim 22, further comprising:
reducing the viscosity of the resin phase by heating the resin phase; and
combining the heated resin phase and the filler phase to form the tacky preceramic-polymer-based adhesive.

30. The method of claim 14, wherein the filler phase includes carbon.

31. The method of claim 14, wherein the resin phase includes at least one of polycarbosilane, polycarbosiloxane, and polysilazane.
